(19) United States
(12) Patent Application Publication
(10) Pub. No.: US 2017/0059756 A1
(43) Pub. Date: Mar. 2, 2017

(54) POLARIZING PLATE AND LIQUID CRYSTAL DISPLAY DEVICE COMPRISING THE SAME

(71) Applicant: DONGWOO FINE-CHEM CO., LTD., Iksan-si (KR)

(72) Inventors: Jihee YOO, Pyeongtaek-si (KR); Kyoungmoon JUNG, Yeonggwang-gun (KR); Seon Yeong KIM, Pyeongtaek-si (KR)

(73) Assignee: DONGWOO FINE-CHEM CO., LTD., Iksan-si (KR)

(21) Appl. No.: 15/245,884

(22) Filed: Aug. 24, 2016

(30) Foreign Application Priority Data
Aug. 26, 2015 (KR) 10-2015-0120324

(51) Int. Cl. G02B 5/30; G02B 1/16; G02F 1/1335

(52) U.S. Cl. CPC G02B 5/305; G02F 1/133528; G02B 1/16

(57) ABSTRACT

The present invention provides a polarizing plate comprising a polarizer, a protective film attached on at least one surface of the polarizer, and an antistatic adhesive layer formed on the protective film, wherein the polarizing plate has a maximum transmittance of 0.2% or less in the short-wavelength area of 400 nm or less, the maximum transmittance being measured after the polarizing plate is left for 250 hours at 60° C. and 90% relative humidity, and the content of iodine in the polarizer is reduced by 5% or more, which is measured for the polarizing plate in which an adhesive layer having no antistatic agent is applied instead of the antistatic adhesive layer, the measurement being performed after the polarizing plate is left for 24 hours at 85° C. and 85% relative humidity; and a liquid crystal display device having the polarizing plate. The polarizing plate according to the present invention has good antistatic property and visible durability with maintaining optical properties under the conditions of moisture/heat resistance.

### TECHNICAL FIELD

The present invention relates to a polarizing plate and a liquid crystal display device comprising the same. Particularly, the present invention provides a polarizing plate having good antistatic property and visible durability with maintaining optical properties under the conditions of moisture/heat resistance, and a liquid crystal display device comprising the polarizing plate.

### BACKGROUND ART

A liquid crystal display (LCD) device has a liquid crystal panel comprising a liquid crystal cell and a polarizing plate attached on both surfaces of the liquid crystal cell through an adhesive layer.

In the LCD, the polarizing plate generally has a multi-layered structure comprising a polarizer obtained by adsorbing and aligning a dichroic pigment on a polyvinyl alcohol (PVA) resin, and a transparent protective film formed one or both surfaces of the polarizer. The polarizer may include an iodine-based polarizer in which an iodine compound is used as the dichroic pigment, and a dye-based polarizer in which a dichroic dye is used as the dichroic pigment. Among these, the iodine-based polarizer is mainly used because it has higher transmittance and higher polarity (higher contrast) than the dye-based polarizer.

Meanwhile, the adhesive used for attachment of the liquid crystal cell and the polarizing plate should satisfy durability of heat resistance, moisture/heat resistance, thermal impact resistance and cold resistance, as well as reworkability made on the occurrence of attachment errors or the presence of impurities, and it should inhibit light leakage generated by contraction stress of the polarizing plate under the conditions of heat resistance. Also, the adhesive should have antistatic property so as to prevent static electricity generated when a release film is removed for attachment of the polarizing plate.

Korean Patent No. 10-1019752 discloses an optical member using an adhesive composition which comprises a copolymer (A) having at least one or two halogen-containing (meth)acrylic acid esters (a1) selected from a halogen-containing acrylic acid ester and a halogen-containing methacrylic acid ester, and at least one or two (meth)acrylates (a2) selected from an acrylic acid ester and a methacrylic acid ester as a copolymerization unit; and an antistatic agent (B) made of an ionic compound. The optical member has good antistatic property, but its optical properties are deteriorated when it comprises a protective film that undergoes high migration of iodine from a polarizer.

### DISCLOSURE

### Technical Problem

It is an object of the present invention to provide a polarizing plate having good antistatic property and visible durability with maintaining optical properties under the conditions of moisture/heat resistance.

It is another object of the present invention to provide a liquid crystal display device having the polarizing plate on at least one surface of a liquid crystal cell.

### Technical Solution

In accordance with one aspect of the present invention, there is provided a polarizing plate comprising a polarizer, a protective film attached on at least one surface of the polarizer, and an antistatic adhesive layer formed on the protective film,

wherein the polarizing plate has a maximum transmittance of 0.2% or less in the short-wavelength area of 400 nm or less, the maximum transmittance being measured after the polarizing plate is left for 250 hours at 60° C. and 90% relative humidity, and

the content of iodine in the polarizer is reduced by 5% or more, which is measured for the polarizing plate in which an adhesive layer having no antistatic agent is applied instead of the antistatic adhesive layer, the measurement being performed after the polarizing plate is left for 24 hours at 85° C. and 85% relative humidity.

In one embodiment of the present invention, the antistatic adhesive layer may be formed from an adhesive composition comprising an acrylic copolymer, a cross-linking agent and an ionic antistatic agent.

In accordance with another aspect of the present invention, there is provided a liquid crystal display device having the polarizing plate on at least one surface of a liquid crystal cell.

### Advantageous Effects

The polarizing plate of the present invention has good antistatic property, in addition to excellent visible durability, heat-resistant and moisture/heat-resistant durability as well as reworkability, and it also does not cause corrosion of a metal.

### BEST MODE

The present invention is, hereinafter, described in more detail.

One embodiment of the present invention relates to a polarizing plate comprising a polarizer, a protective film attached on at least one surface of the polarizer, and an antistatic adhesive layer formed on the protective film,

wherein the polarizing plate has a maximum transmittance of 0.2% or less in the short-wavelength area of 400 nm or less, the maximum transmittance being measured after the polarizing plate is left for 250 hours at 60° C. and 90% relative humidity, and

the content of iodine in the polarizer is reduced by 5% or more, which is measured for the polarizing plate in which an adhesive layer having no antistatic agent is applied instead of the antistatic adhesive layer, the measurement being performed after the polarizing plate is left for 24 hours at 85° C. and 85% relative humidity.

In one embodiment of the present invention, the reduction content of iodine refers to the amount of iodine migrated from the polarizer when the polarizing plate in which an adhesive layer having no antistatic agent is applied instead of the antistatic adhesive layer is attached on a glass substrate and the polarizing plate is left for 24 hours at 85° C. and 85% relative humidity. Specifically, the amount of iodine in each layer of the polarizer, the protective film and the adhesive layer is measured by combustion ion chromatography (IC) analysis and the relative amount of iodine migrated from the polarizer to the adhesive layer and the protective film is calculated on the basis of the total amount of iodine. Thereby, the reduction content of iodine is determined.

The polarizing plate according to one embodiment of the present invention can control the reduction content of iodine to 5% or more, thereby exhibiting improved durability of heat resistance and moisture/heat resistance.

In one embodiment of the present invention, the maximum transmittance of the polarizing plate in the short-wavelength area of 400 nm or less is measured after the polarizing plate is left for 250 hours at 60° C. and 90% relative humidity, and the measurement may be performed using a UV-VIS spectrophotometer which is conventionally used in the art.

The polarizing plate according to one embodiment of the present invention can maintain its maximum transmittance in the short-wavelength area of 400 nm or less within 0.2% or less, thereby exhibiting excellent visible durability and heat-resistant and moisture/heat-resistant durability even though the polarizing plate comprises a protective film that undergoes high migration of iodine from a polarizer, and an adhesive layer containing an antistatic agent.

In the polarizing plate according to one embodiment of the present invention, the reduction content of iodine and the maximum transmittance in the short-wavelength area of 400 nm or less may be properly controlled by adjusting the kind and thickness of the protective film, and the kind and composition of components contained in the adhesive layer-forming composition.

<Polarizer>

In one embodiment of the present invention, the polarizer is obtained by adsorbing and aligning a dichroic pigment on a polyvinyl alcohol resin film. The dichroic pigment may be iodine.

The polyvinyl alcohol resin composing the polarizer may be made of polyvinyl acetate being a homopolymer of vinyl acetate, or a copolymer of vinyl acetate and other monomer copolymerizable with the vinyl acetate. Examples of the other monomer copolymerizable with the vinyl acetate may include unsaturated carboxylic acid, unsaturated sulfonic acid, olefin, vinyl ether, and ammonium group-containing acrylamide. The thickness of the polarizer is not particularly limited if it is within a conventional range.

<Protective Film>

In one embodiment of the present invention, the protective film is preferred to have good transparency, mechanical strength, thermal stability, moisture-shielding property, and isotropicity. For example, polyester films such as polyethylene terephthalate, polyethylene isophthalate and polybutylene terephthalate; cellulose films such as diacetyl cellulose and triacetyl cellulose; polycarbonate films; acrylate films such as polymethyl (meth)acrylate and polyethyl (meth)acrylate; styrene films such as polystyrene and acrylonitrile-styrene copolymer; polyolefin films such as polyethylene, polypropylene, polyolefin having a cyclic or norbonene structure, and ethylene-propylene copolymer; polyimide films; polyethersulfone films; and sulfone films may be used, and the thickness thereof is also not particularly limited.

<Adhesive Layer>

In one embodiment of the present invention, the adhesive layer may be formed from an adhesive composition comprising an acrylic copolymer, a cross-linking agent and an ionic antistatic agent.

The acrylic copolymer may comprise a (meth)acrylate monomer having a C₁₋₁₄ alkyl group and a polymerizable monomer having a cross-linkable functional group.

The (meth)acrylate refers to acrylate and methacrylate.

Specific examples of the (meth)acrylate monomer having a C₁₋₁₄ alkyl group may include n-butyl(meth)acrylate, 2-butyl(meth)acrylate, t-butyl(meth)acrylate, 2-ethylhexyl(meth)acrylate, ethyl (meth)acrylate, methyl (meth)acrylate, n-propyl(meth)acrylate, isopropyl(meth)acrylate, pentyl (meth)acrylate, n-octyl(meth)acrylate, isooctyl(meth)acrylate, nonyl (meth)acrylate, decyl (meth)acrylate, lauryl (meth)acrylate, etc. Among these, n-butyl acrylate, methyl acrylate and a mixture thereof are preferred. These monomers may be used alone or in combination of two or more.

The polymerizable monomer having a cross-linkable functional group is used to improve the cohesive strength or adhesive strength of the adhesive composition through chemical bonding with the cross-linking agent as described below, thereby providing durability and cutting property, and it may include a monomer having a hydroxyl group, a monomer having a carboxyl group, a monomer having an amide group, a monomer having a tertiary amine group, etc. These monomers may be used alone or in combination of two or more.

Examples of the monomer having a hydroxyl group may include 2-hydroxyethyl(meth)acrylate, 2-hydroxypropyl(meth)acrylate, 2-hydroxybutyl(meth)acrylate, 4-hydroxybutyl(meth)acrylate, 6-hydroxyhexyl(meth)acrylate, 2-hydroxyethylene glycol (meth)acrylate, 2-hydroxypropylene glycol (meth)acrylate, hydroxyalkylene glycol (meth)acrylate having a C₂₋₄ alkylene group, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, 10-hydroxydecyl vinyl ether, etc. Among these, 2-hydroxyethyl(meth)acrylate and 4-hydroxybutyl vinyl ether are preferred.

Examples of the monomer having a carboxyl group may include monobasic acids such as (meth)acrylic acid and crotonic acid; dibasic acids such as maleic acid, itaconic acid and fumaric acid, and monoalkylesters thereof; 3-(meth)acryloylpropionic acid; succinic anhydride ring-opening adducts of 2-hydroxyalkyl (meth)acrylate having a C₂₋₃ alkyl group, succinic anhydride ring-opening adducts of hydroxyalkylene glycol (meth)acrylate having a C₂₋₄ alkylene group, compounds obtained by ring-opening addition of succinic anhydride to caprolactone adduct of 2-hydroxyalkyl (meth)acrylate having a C₂₋₃ alkyl group, etc. Among these, (meth)acrylic acid is preferred.

Examples of the monomer having an amide group may include (meth)acrylamide, N-isopropylacrylamide, N-tert-butylacrylamide, 3-hydroxypropyl(meth)acrylamide, 4-hydroxybutyl(meth)acrylamide, 6-hydroxyhexyl(meth)acrylamide, 8-hydroxyoctyl(meth)acrylamide, 2-hydroxyethylhexyl(meth)acrylamide, etc. Among them, (meth)acrylamide is preferred.

Examples of the monomer having a tertiary amine group may include N,N-(dimethylamino)ethyl(meth)acrylate, N,N-(diethylamino)ethyl(meth)acrylate, N,N-(dimethylamino)propyl(meth)acrylate, etc.

The polymerizable monomer having a cross-linkable functional group is preferably present in an amount of 0.05 to 10 parts by weight, more preferably 0.1 to 8 parts by weight, based on 100 parts by weight of the (meth)acrylate monomer having a C₁₋₁₄ alkyl group. If the amount of the polymerizable monomer having a cross-linkable functional group is less than 0.05 parts by weight, the cohesive strength may be lowered to deteriorate durability. If the amount of the polymerizable monomer having a cross-linkable functional group is more than 10 parts by weight, the adhesive strength may be deteriorated by high gel fraction to cause durability problems.

In addition to the above monomers, the acrylic copolymer may further contain other monomers within a range not to degrade the adhesive strength, for example 10 wt % or less.

The acrylic copolymer can be prepared, without limitation, using bulk polymerization, solution polymerization, emulsion polymerization or suspension polymerization, etc. which are conventionally known in the art. Among these, the solution polymerization is preferred. Further, a solvent, a polymerization initiator, a chain transfer agent for controlling the molecular weight, etc. which are conventionally known in the art may be used for the polymerization.

The acrylic copolymer may have a weight average molecular weight (polystyrene-converted, M_{w}) of 500,000 to 1,700,000, preferably 800,000 to 1,500,000, as measured by gel permeation chromatography (GPC).

The cross-linking agent is used to enhance the cohesive strength of the adhesive by suitably cross-linking the copolymers. By way of examples, the cross-linking agent may include, without limitation, isocyanate compounds, epoxy compounds, etc. These compounds may be used alone or in combination of two or more.

Examples of the isocyanate compounds may include diisocyanate compounds such as tolylene diisocyanate, xylene diisocyanate, 2,4-diphenylmethane diisocyanate, 4,4-diphenylmethane diisocyanate, hexamethylene diisocyanate, isophorone diisocyanate, tetramethylxylene diisocyanate, and naphthalene diisocyanate; and multifunctional isocyanate compounds having three functional groups such as adducts obtained by reacting 1 mol of polyhydric alcohol compounds such as trimethylolpropane with 3 mol of diisocyanate compounds, isocyanurates obtained by self-condensation of 3 mol of diisocyanate compounds, biurets obtained by condensation of diisocyanate ureas prepared from 2 mol of diisocyanate compounds with 1 mol of diisocyanate compound, triphenylmethane triisocyanate, and methylenebistriisocyanate.

Examples of the epoxy compounds may include ethylene glycol diglycidyl ether, diethylene glycol diglycidyl ether, polyethylene glycol diglycidyl ether, propylene glycol diglycidyl ether, tripropylene glycol diglycidyl ether, polypropylene glycol diglycidyl ether, neopentylglycol diglycidyl ether, 1,6-hexanediol diglycidyl ether, polytetramethylene glycol diglycidyl ether, glycerol diglycidyl ether, glycerol triglycidyl ether, diglycerol polyglycidyl ether, polyglycerol polyglycidyl ether, resorcin diglycidyl ether, 2,2-dibromoneopentylglycol diglycidyl ether, trimethylolpropane triglycidyl ether, pentaerythritol polyglycidyl ether, sorbitol polyglycidyl ether, adipic acid diglycidyl ester, phthalic acid diglycidyl ester, tris(glycidyl)isocyanurate, tris(glycidoxyethyl)isocyanurate, 1,3-bis(N,N-glycidylaminomethyl)cyclohexane, N,N,N′,N′-tetraglycidyl-m-xylylenediamine, etc.

In addition to the isocyanate compounds and epoxy compounds, melamine compounds or aziridine compounds may be further used alone or in combination of two or more.

Examples of the melamine compounds may include hexamethylolmelamine, hexamethoxymethylmelamine, hexabutoxymethylmelamine, etc.

Examples of the aziridine compounds may include N,N′-toluene-2,4-bis(1-aziridine-carboxamide), N,N′-diphenylmethane-4,4′-bis(1-aziridine-carboxamide), bisisophthaloyl-1-(2-methylaziridine), tri-1-aziridinylphosphine oxide, etc.

The cross-linking agent may be preferably contained in an amount of 0.1 to 15 parts by weight, more preferably 0.1 to 5 parts by weight, based on 100 parts by weight of the acrylic copolymer. If the amount of the cross-linking agent is less than 0.1 parts by weight, the cohesive strength may be decreased due to insufficient cross-linking, thereby resulting in durability deterioration, e.g., looseness, and damaging cutting property. If the amount of the cross-linking agent is more than 15 parts by weight, the residual stress cannot be sufficiently relaxed due to excessive cross-linking.

The ionic anti-static agent may be a compound formed by ion combination of a cation and an anion.

As the cation, an organic cation such as ammonium, phosphonium and sulfonium, or an alkali metal cation may be used. Specific examples of the organic cation may include quaternary ammonium having 4 alkyl groups substituted, such as tetrabutyl ammonium; pyridinium having an alkyl group substituted on the nitrogen of pyridine, such as 1-ethylpyridinium, 1-butylpyridinium, 1-hexylpyridinium, 1-butyl-3-methylpyridinium, 1-butyl-4-methylpyridinium, 1-hexyl-3-methylpyridinium, 1-hexyl-4-methylpyridinium, 1-butyl-3,4-dimethylpyridinium, 1-octyl-4-methylpyridinium; imidazolium having alkyl groups substituted at 1 and 3 positions of imidazole, such as 1-methyl-3-butylimidazolium and 1-methyl-3-hexylimidazolium; quaternary phosphonium having 4 alkyl groups, such as tetrabutylphosphonium; tertiary sulfonium having 3 alkyl groups, such as tributyl sulfonium, etc. Examples of the alkali metal may include lithium, sodium, potassium or cesium, preferably lithium, sodium or potassium. These may be used alone or in combination of two or more.

As the anion, OTf⁻ (trifluoromethane sulfonate), OTs⁻ (toluene-4-sulfonate), OMs⁻ (methane sulfonate), Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, etc. may be used.

The amount of the anti-static agent is not particularly limited and may range from 0.1 to 1.0 parts by weight based on 100 parts by weight of the acrylic copolymer. When the amount of the anti-static agent satisfies such range, good anti-static property can be obtained and the optical property and durability of the polarizer can be remarkably enhanced.

The adhesive composition, if necessary, may further comprise an additive such as a silane coupling agent, an adhesion enhancing resin, an antioxidant, a corrosion inhibitor, a leveling agent, a surface lubricant, a dye, a pigment, a defoaming agent, a filler and a light stabilizer, in order to control adhesion, cohesion, viscosity, elasticity, glass transition temperature, etc.

The adhesive layer may be laminated on the polarizing plate by a method which is conventionally used in the art, without limitation. For example, the adhesive composition is directly applied on the protective film by various methods including flow coating and coating methods using a bar coater, air knife, gravure, reverse roll, kiss roll, spray or blade, and dried to form the adhesive layer, and the adhesive layer is laminated with the polarizing plate. Also, the adhesive layer may be formed on a silicon-coated release film by the same method as described above to obtain an adhesive sheet, to which a silicon-coated release film having different peeling strength is laminated using a rolling compressor to obtain an adhesive transfer tape, and the tape may be attached to the polarizing plate.

The thickness of the adhesive layer formed may be controlled according to the adhesiveness thereof, and it may be conventionally 3 to 100 μm, preferably 10 to 100 μm.

Also, the adhesive layer may be laminated with a release film for protecting the adhesive layer thereon. The release film is not particularly limited if it is conventionally used in the art. Specific examples of the release film may include films made of polyolefins such as polyethylene, polypropylene, poly-1-butene, poly-4-methyl-1-pentene, a copolymer of ethylene-propylene, a copolymer of ethylene-1-buten, a copolymer of ethylene-vinyl acetate, a copolymer of ethylene-ethyl acrylate, a copolymer of ethylene-vinyl alcohol, etc.; polyesters such as polyethylene terephthalate, polyethylene naphthalate, polybutylene terephthalate, etc.; polyacrylates; polystyrenes; polyamides such as nylon 6, partially aromatic polyamide, etc.; polyvinyl chlorides; polyvinylidene chlorides; polycarbonates, etc. These films may be used after suitable releasing treatment with silicon, fluorine or silica powders.

The polarizing plate of the present invention may be applied to typical liquid crystal display devices. Particularly, the polarizing plate may be used to fabricate a liquid crystal display device including a liquid crystal panel wherein the polarizing plate having the adhesive layer is laminated on at least one surface of a liquid crystal cell.

Therefore, one embodiment of the present invention relates to a liquid crystal display device having the polarizing plate on at least one surface of a liquid crystal cell.

The present invention is further illustrated by the following examples, comparative examples and experimental examples, which are not to be construed to limit the scope of the invention.

### Preparation Example 1

### Preparation of Acrylic Copolymer

To a 1 L reactor equipped with a cooler and subjected to nitrogen gas flow were added a mixture of monomers listed in Table 1 and 100 parts by weight of ethyl acetate as a solvent. Then, nitrogen gas was purged for 1 hour to remove oxygen, followed by maintaining the temperature to 62° C. After uniformly stirring the mixture, 0.07 parts by weight of azobisisobutyronitrile (AIBN) as a reaction initiator was added thereto, and the resulting mixture was reacted for 6 hours to give an acrylic copolymer having a weight average molecular weight listed in Table 1.

### Examples 1 to 7 and Comparative Examples 1 to 3

### Preparation of Adhesive-Attached Polarizing Plate

Components listed in Table 1 were mixed in parts by weight, and each mixture was diluted with ethyl acetate to give an adhesive composition having a solid concentration of 20 wt %.

Each adhesive composition thus obtained was applied on a silicon releasing agent-coated film in a thickness of 20 μm, and dried at 100° C. for 1 minute to form an adhesive layer.

After attaching a protective film listed in Table 1 on one surface of an iodine-based polarizer, the adhesive layer formed above was laminated by way of adhesion on the protective film, followed by curing at 23° C. and 60% relative humidity to prepare an adhesive-attached polarizing plate.

### Experimental Example 1

The adhesive-attached polarizing plates prepared in the Examples and the Comparative Examples were measured for their properties. The results thereof are shown in Table 1.

(1) Reduction Content of Iodine

The laminate of the iodine-based polarizer and the protective film was applied with an adhesive layer having no antistatic agent, instead of the antistatic adhesive layer, and then attached on a glass substrate. After leaving the laminate for 24 hours under the conditions of moisture/heat resistance, i.e., 85° C. and 85% relative humidity, the amount of iodine in each layer of the polarizer, the protective film and the adhesive layer was measured by combustion ion chromatography (IC) analysis and the relative amount of iodine migrated from the polarizer to the adhesive layer and the protective film interposed between the polarizer and the adhesive layer was calculated on the basis of the total amount of iodine. Thereby, the reduction content of iodine was determined.

<Combustion Ion Chromatography (IC) Analysis>
Analyzer: Dionex ICS 2100,
Injection Volume: 25 μl
Flow Rate: 1.0 ml/min
Detection using an anion self-regenerating suppressor (ASRS) at 100 mA under gradient conditions
Sampling: Each layer of the polarizer, the adhesive layer, and the protective film interposed between the polarizer and the adhesive layer was separated to obtain a sample. 0.1 g of Each sample was put into a gelatin capsule, and was subject to combustion together with an absorption solution in an oxygen bomb. The absorption solution was recovered and used for analysis.

(2) Maximum Transmittance (%) in Short-Wavelength Area

The prepared adhesive-attached polarizing plates was cut into a size of 4 cm×4 cm to obtain a sample. The sample was attached to a holder for measurement and left for 250 hours at 60° C. and 90% relative humidity, followed by measuring its maximum transmittance in the short-wavelength area of 400 nm or less at a TD transmission spectrum obtained using a UV-VIS spectrophotometer (V-7100, JASCO).

(3) Anti-Static Property

The release film of the prepared adhesive-attached polarizing plates was removed, and the adhesive layer of the polarizing plate was measured for its surface electrical resistivity at 3 positions thereof using MCP-HT450 (Mitsubishi Chemical). The measurement was repeated 10 times, and the results thereof were represented by an average value (Ω/ [symbol] ).

(4) Visible Durability (Appearance Durability)

The prepared adhesive-attached polarizing plates was cut into the size of 300 mm×220 mm and attached to a glass substrate (#1737, Corning Inc.) to obtain a sample. The sample was treated for 20 minutes in an autoclave under the conditions of 5 atm and 50° C. and then left for 300 hours in an oven of 60° C. and 90% relative humidity, followed by visually observing the occurrence of deformation (such as looseness and peelings) and bubbles.

<Evaluation Criteria>

◯: no deformation, bubble and stain (Good)

Δ: some deformation, bubble and stain (Average)

x: many deformation, bubble and stain (Poor)

(5) Durability (Heat Resistance, Moisture/Heat Resistance)

The prepared adhesive-attached polarizing plate was cut into the size of 90 mm×170 mm and the release film was removed from the polarizing plate, the cut piece of the polarizing plate was attached to both surfaces of a glass substrate (110 mm×190 mm×0.7 mm) such that the optical absorption axes cross at right angles, to give a sample. The pressure applied in the above process was 5 kg/cm² and the process was conducted in a clean room so as to prevent bubbles or impurities from being generated. In order to evaluate heat resistance, the occurrence of bubbling or peeling was observed after leaving the sample for 1,000 hours at 90° C. In order to evaluate heat/moisture resistance, the occurrence of bubbling or peeling was observed after leaving the sample for 1,000 hours under the conditions of 65° C. and 90% relative humidity. Prior to each evaluation, the sample was left for 24 hours at room temperature.

<Evaluation Criteria>

⊚: no bubbles or peelings

◯: bubbles or peelings (<5)

Δ: 5≦bubbles or peelings<10

x: 10≦bubbles or peelings

(6) Reworkability

The prepared adhesive-attached polarizing plates was cut into the size of 25 mm×100 mm. After removing the release film, the plate was subject to lamination to a glass substrate (#1737, Corning Inc.) at a pressure of 0.25 MPa, followed by treatment for 20 minutes in an autoclave under the conditions of 5 atm and 50° C. to obtain a sample. The sample was stored for 10 hours in an oven set to 80° C., i.e., heat-resistant conditions. Then, the sample was left for 120 hours at room temperature, followed by delamination at a rate of 1.3 cm/s.

<Evaluation Criteria>

◯: Adhesive is clearly delaminated from the glass substrate without the breakage of the polarizing plate

x: Adhesive is remained in the glass substrate or the polarizing plate is broken on delamination

(7) Corrosion Resistance of Metal

The prepared adhesive-attached polarizing plates was left for 7 days under the conditions of 23° C. and 50% relative humidity. After attaching an aluminum foil on the adhesive layer, the polarizing plate was left for 2 days under the conditions of 60° C. and 90% relative humidity, followed by observation for its corrosion resistance.

<Evaluation Criteria>

◯: Aluminum foil is not changed

x: Aluminum foil is subject to whiteness

TABLE 1

| | | Examples | | | | | | | Comparative Examples | | |
|---|---|---|---|---|---|---|---|---|---|---|---|
| | | 1 | 2 | 3 | 4 | 5 | 6 | 7 | 1 | 2 | 3 |
| Polymer | BA | 87 | 87 | 87 | 87 | 87 | 87 | 87 | 87 | 87 | 87 |
| (parts by | MA | 10 | 10 | 10 | 10 | 10 | 10 | 10 | 10 | 10 | 10 |
| weight) | 2HEA | 2.0 | 2.0 | 2.0 | 2.0 | 2.0 | 2.0 | 4.0 | 2.0 | 2.0 | 2.0 |
| | AA | 1.0 | 1.0 | 1.0 | 1.0 | 1.0 | 1.0 | 1.0 | 1.0 | 1.0 | 1.0 |
| | Molecular | 1,500,000 | 1,500,000 | 1,500,000 | 1,500,000 | 1,500,000 | 1,200,000 | 800,000 | 1,500,000 | 1,500,000 | 1,500,000 |
| | Weight | | | | | | | | | | |
| Cross-linking | A-1 | 0.8 | 0.8 | 0.8 | 0.8 | | 0.8 | 0.8 | 0.8 | 0.8 | 0.8 |
| Agent | A-2 | | | | | 0.8 | | | | | |
| (parts by | | | | | | | | | | | |
| weight) | | | | | | | | | | | |
| Ionic | B-1 | 0.6 | 0.4 | 0.4 | | 0.4 | 0.4 | 0.4 | 2.0 | 1.5 | 0.6 |
| Antistatic | B-2 | | | | 0.6 | | | | | | |
| Agent | | | | | | | | | | | |
| (parts by | | | | | | | | | | | |
| weight) | | | | | | | | | | | |

| | | | | | | | | | | |
|---|---|---|---|---|---|---|---|---|---|---|
| Substrate | NRT | NRT | NRT | NRT | NRT | NRT | NRT | NRT | NRT | RM-147 |
| (Polarizer-protective Film) | 60 μm | 60 μm | 40 μm | 60 μm | 60 μm | 60 μm | 60 μm | 60 μm | 60 μm | 53 μm |
| Reduction Content (%) of | 8 | 8 | 12 | 8 | 8 | 8 | 8 | 8 | 8 | 1 |
| Iodine in Polarizer under | | | | | | | | | | |
| Conditions of Moisture/heat | | | | | | | | | | |
| Resistance | | | | | | | | | | |
| Maximum Transmittance | 0.08 | 0.07 | 0.12 | 0.07 | 0.05 | 0.07 | 0.09 | 0.4 | 0.3 | 0.02 |
| (%) in Short-wavelength | | | | | | | | | | |
| Area | | | | | | | | | | |
| Antistatic Property (Ω/□) | 9.0E+10 | 5.0E+11 | 4.0E+11 | 5.0E+10 | 3.2E+11 | 4.2E+11 | 3.2E+11 | 1.8E+10 | 4.2E+10 | 1.0E+11 |
| Visible durability | ⊚ | ⊚ | ⊚ | ⊚ | ⊚ | ⊚ | ⊚ | X | X | ⊚ |
| Heat Resistance (90° C.) | ⊚ | ⊚ | ⊚ | ◯ | ◯ | ◯ | ◯ | ◯ | X | X |
| Moisture/Heat Resistance | ◯ | ⊚ | ⊚ | ⊚ | ◯ | ◯ | ⊚ | ◯ | ◯ | X |
| (65° C., 90%) | | | | | | | | | | |
| Reworkability | ◯ | ◯ | ◯ | ◯ | ◯ | ◯ | ◯ | ◯ | ◯ | ◯ |
| Corrosion Resistance of | ◯ | ◯ | ◯ | ◯ | ◯ | ◯ | ◯ | X | X | ◯ |
| Metal | | | | | | | | | | |

BA: n-Butylacrylate
MA: Methylacrylate
HEA: 2-Hydroxyethylacrylate
AA: Acrylic Acid
A-1: Coronate-L (Adduct of Trimethylolpropane (TMP) with Tolylene Diisocyanate (TDI), Nippon Polyurethane Industry)
A-2: D11ON (Adduct of Xylene Diisocyanate(XDI), Mitsui Chemicals)
B-1: 1-Octyl-4-methylpyridinium Hexafluorophosphate (ILP18-2, Kongyoung Chemical)
B-2: 1-Hexylpyridinium Hexafluorophosphate (ILP14, Kongyoung Chemical)
NRT 40 μm (Triacetyl Cellulose, FujiFilm)
NRT 60 μm (Triacetyl Cellulose, FujiFilm)
RM-147 53 μm (Polycarbonate, Teijin)

As shown in Table 1, the polarizing plates of Examples 1 to 7 exhibited good antistatic property, durability (viewing, heat resistance and moisture/heat resistance) and reworkability, as well as no corrosion of metal. In contrast, the polarizing plates of Comparative Examples 1 and 2 exhibited poor durability and caused corrosion of metal as these polarizing plates had a maximum transmittance higher than 0.2% in the short-wavelength area of 400 nm or less, which was measured after the polarizing plates were left for 250 hours at 60° C. and 90% relative humidity. Also, the polarizing plate of Comparative Example 3 exhibited poor durability in terms of heat resistance and moisture/heat resistance as it had a reduction content of iodine in the polarizer within the range less than 5% on measurement after leaving it for 24 hours at 85° C. and 85% relative humidity.

Although particular embodiments of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

1. A polarizing plate comprising a polarizer, a protective film attached on at least one surface of the polarizer, and an antistatic adhesive layer formed on the protective film,
wherein the polarizing plate has a maximum transmittance of 0.2% or less in the short-wavelength area of 400 nm or less, the maximum transmittance being measured after the polarizing plate is left for 250 hours at 60° C. and 90% relative humidity, and
the content of iodine in the polarizer is reduced by 5% or more, which is measured for the polarizing plate in which an adhesive layer having no antistatic agent is applied instead of the antistatic adhesive layer, the measurement being performed after the polarizing plate is left for 24 hours at 85° C. and 85% relative humidity.

2. The polarizing plate of claim 1, wherein the antistatic adhesive layer is formed from an adhesive composition comprising an acrylic copolymer, a cross-linking agent and an ionic antistatic agent.

3. The polarizing plate of claim 2, wherein the adhesive composition comprises the ionic antistatic agent in an amount of 0.1 to 1.0 parts by weight based on 100 parts by weight of the acrylic copolymer.

4. The polarizing plate of claim 1, which has a release film laminated on the antistatic adhesive layer.

5. A liquid crystal display device having the polarizing plate of claim 1 on at least one surface of a liquid crystal cell.

6. A liquid crystal display device having the polarizing plate of claim 2 on at least one surface of a liquid crystal cell.

7. A liquid crystal display device having the polarizing plate of claim 3 on at least one surface of a liquid crystal cell.
